(19) United States
(12) Patent Application Publication
(10) Pub. No.: US 2008/0241304 A1
(43) Pub. Date: Oct. 2, 2008

(54) Slide having a fixing mechanism of a slide insert

(76) Inventors: Chih-Yu Chen, Tu-Cheng City (TW); Jian-Guang Huang, Tu-Cheng City (TW); Yun-Ging He, Tu-Cheng City (TW); Chun-Yan Wu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,320

(22) Filed: Mar. 26, 2007

(51) Int. Cl. B29C 45/33

(52) U.S. Cl. 425/192 R

(57) ABSTRACT

A slide having a fixing mechanism of a slide insert includes a slide body, a slide insert and a slide core. The slide body has a front wall and two sidewalls. The front wall defines a receiving hole. The sidewall defines an inlay cavity. The inlay cavity passes through the receiving hole. The slide insert held in the receiving hole has a moldboard on one end, and on one side it defines a locating opening. The moldboard stretches out of the front wall of the slide body. The slide core is inserted in the inlay cavity of the slide body and further inserted in the locating opening of the slide insert. Then the slide insert is fixed in the slide body.

### BACKGROUND OF THE INVENTION

1. Field of the Invention

The present invention relates to a slide, and more particularly to a slide having fixing mechanism of slide insert.

2. The Related Art

A conventional mold includes a slide and a slide insert. The front of the slide defines a receiving hole. Both sides of the slide define screw holes which pass through the receiving hole. The slide insert is held in the receiving hole with the front end stretching out of the front of the slide. Usually the front end of the slide insert has a moldboard. Both sides of the slide insert either define screw holes. Two screws are inserted into the screw holes of the slide and further inserted into the screw holes of the slide insert. Then the slide insert is fixed in the slide.

The aforesaid slide utilizes the screws to fix the slide insert in the slide. However, the screws just adapt to fixing the larger slide insert in the slide. Sometimes when products are very small, in order to accord with the small products, the slide insert must be very small. That is, the small slide insert cannot be fixed in the slide by the screws. Then it causes the products shaped not well.

### SUMMARY OF THE INVENTION

Accordingly, an object of the present invention is to provide a slide having a fixing mechanism of a slide insert to fix a slide insert steadily when the slide insert is small. The slide includes a slide body, the slide insert and a slide core. The slide body has a front wall, a top wall and two sidewalls. The front wall defines a receiving hole. The sidewall defines an inlay cavity. The inlay cavity passes through the receiving hole. The slide insert held in the receiving hole has a moldboard on one end, and the moldboard stretches out of the front wall of the slide body. A locating opening is defined on one side of the slide insert. The slide core is inserted in the inlay cavity of the slide body and fixed in the locating opening of the slide insert.

As described above, the slide core is inserted in the inlay cavity of the slide body and further inserted in the locating opening of the slide insert. Then the slide insert is fixed in the slide body steadily although the slide insert is small to accord with a small product.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a slide having a fixing mechanism of a slide insert of the present invention;

FIG. 2 is an assembled view of the slide insert and a slide core of the present invention;

FIG. 3 is an exploded view of the slide having the fixing mechanism of the slide insert, an angular pin and an angle wedge;

FIG. 4 is an assembled view of FIG. 3 with a core insert; and

FIG. 5 is an assembled view of FIG. 4 with a cavity insert.

### DETAILED DESCRIPTION OF THE PREFERRED EMBODIMENT

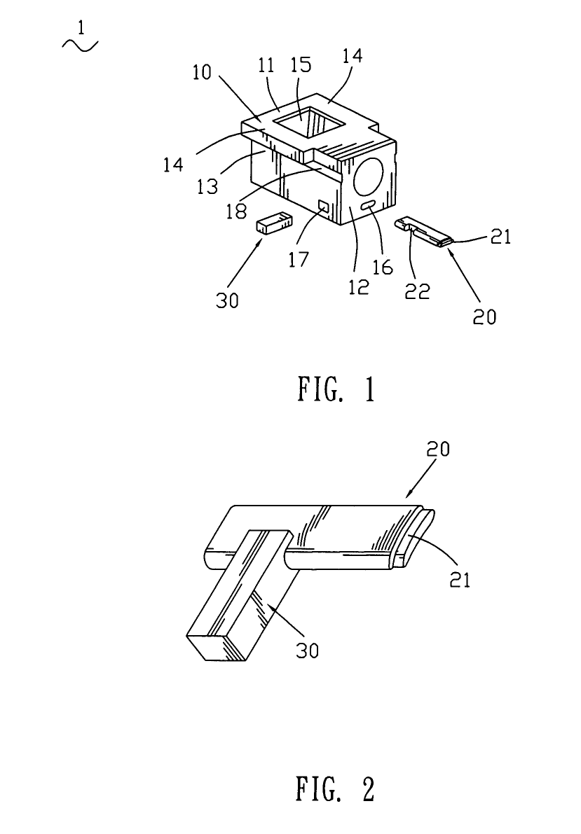

Referring to FIG. 1 together with FIG. 2, a slide having fixing mechanism of slide insert 1 includes a slide body 10, a slide insert 20 and a slide core 30.

The slide body 10 has a top wall 11, a front wall 12 and two sidewalls 13. The top wall 11 stretches out from a portion of each side to form a buckling block 14 and then two preventing openings 18 are formed at the front of the top wall 11. The back of the top wall 11 defines an inserting cavity 15 which stretches from the top wall 11 to the bottom of the slide body 10. The inserting cavity 15 inclines backwards. The front wall 12 defines a receiving hole 16 at the bottom. The sidewall 13 is plane, and one of the sidewalls 13 defines an inlay cavity 17 at the lower part. The inlay cavity 17 and the receiving hole 16 are on the same level with the inlay cavity 17 passing through the receiving hole 16.

The slide insert 20 inserted in the receiving hole 16 of the slide body 10 has a moldboard 21 on one end to mold a hole of a product. One side of the slide insert 20 defines a locating opening 22 which is rectangular. The slide core 30 which is inserted in the inlay cavity 17 of the slide body 10 is a rectangular batten and can be fastened in the locating opening 22 of the slide insert 20

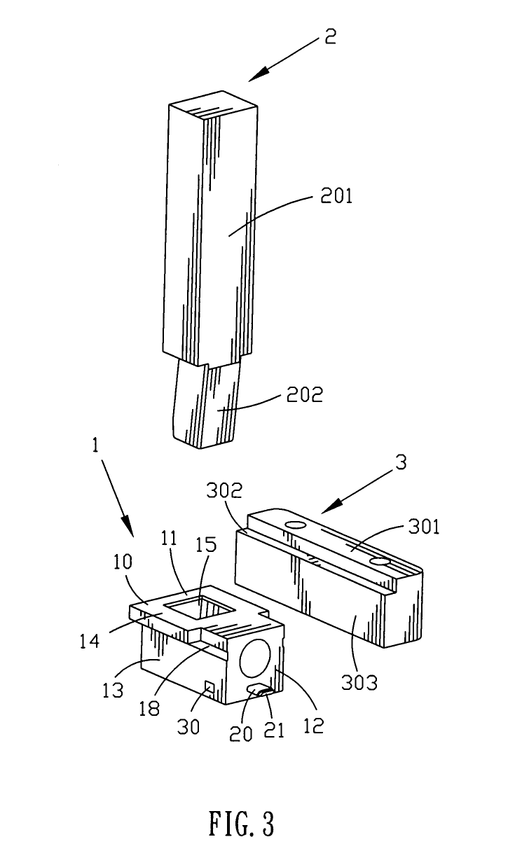

Please refer to FIGS. 3-5, a mold with the slide having fixing mechanism of slide insert 1 further includes an angular pin 2, an angle wedge 3, a core insert 4 and a cavity insert 5 located above the core insert 4. Between the core insert 4 and the cavity insert 5 it forms a mold cavity 45 to hold a model product 6.

The angular pin 2 fastened on a top clamping plate (not shown) to match with the inserting cavity 15 of the slide body 10 includes a vertical supporting pillar 201. At the bottom surface the supporting pillar 201 it protrudes downward and forms an inclined block 202 which inclines backwards.

The angle wedge 3 is placed horizontally and has a top surface 301. The inner side of the top surface 301 is defined a slide track 302 to match with the buckling block 14 of the slide body 10. The inner side of the angle wedge 3 is slick and parallel with the sidewall 13 of the slide body 10 to define a loading wall 303. The buckling block 14 and the sidewall 13 can slide along the slide track 302 and the loading wall 303.

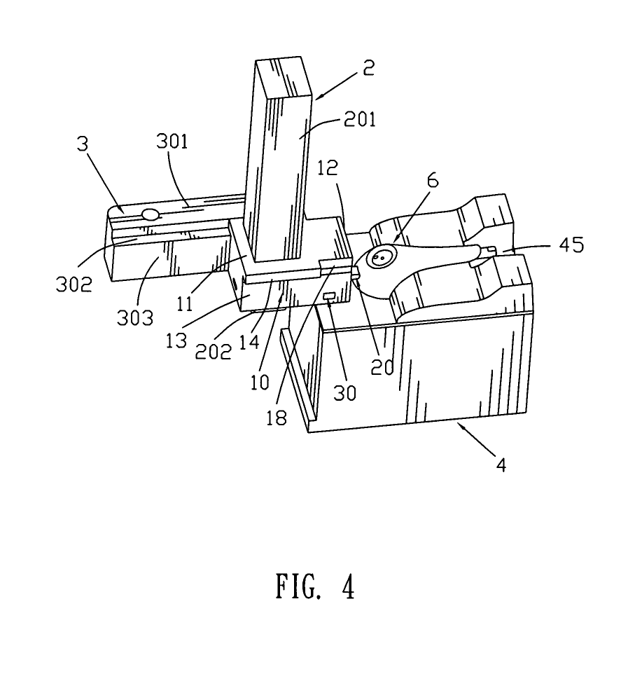

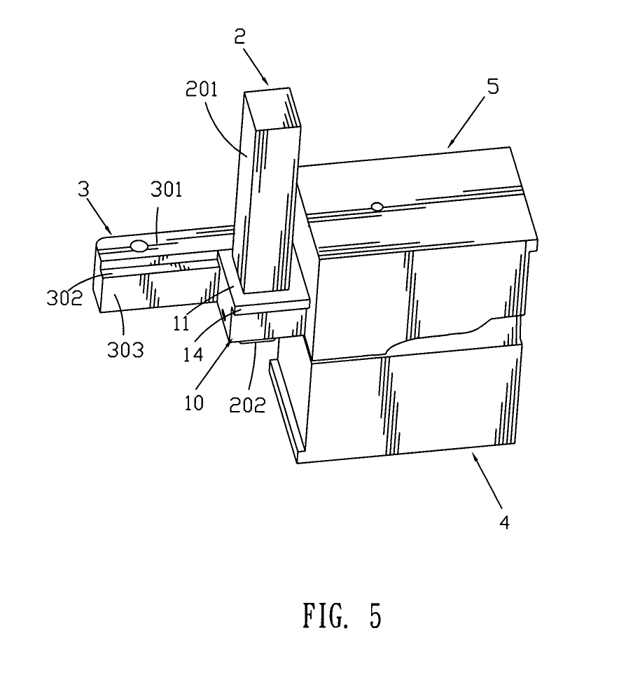

Referring to FIGS. 4-5 again, the slide 1 is assembled in the mold. The cavity insert 5 buckles with the core insert 4. The slide insert 20 is inserted in the receiving hole 16 of the slide body 10 with the moldboard 21 stretching out of the front wall 12. The slide core 30 is inserted in the inlay cavity 17 of the slide body 10 and further inserted in the locating opening 22 of the slide insert 20. Then the slide insert 20 is fixed in the slide body 10. The buckling block 14 of the slide body 10 covers on the slide track 302 of the angle wedge 3. The inclined block 202 of the angular pin 2 is inserted in the inserting cavity 15 of the slide body 10 and bulges out of the bottom of the inserting cavity 15. Then the supporting pillar 201 is placed on the top wall 11 of the slide body 10. The process of the inclined block 202 inserting in the inserting cavity 15 drives the assembly of the slide body 10, the slide insert 20 and the slide core 30 to slide forward along the slide track 302 and the loading wall 303 of the angle wedge 3. Then the preventing openings 18 are inserted in the cavity insert 5. The front of the buckling block 14 withstands the front surface of the cavity insert 5. The moldboard 21 passes through the cavity insert 5 to reach the front surface of the model product 6. Molten plastic materials are injected into the mold cavity 45 to mold a plastic product.

When the plastic product is taken out from the mold cavity 45, first take the angular pin 2 out of the inserting cavity 15 of the slide body 10. In the process of taking out of the angular pin 2, the force coming from the action of the slide body 10 on the angular pin 2 causes the slide body 10 sliding backward along the slide track 302 and the loading wall 303. Then it brings the moldboard 21 of the slide insert 20 to separate from the cavity insert 5 and further brings the slide insert 20 to separate from the model product 6. While the cavity insert 5 and the core insert 4 are opened, the plastic product is ejected from the mold cavity 45 so as to be taken out.

According to the present invention, the slide core 30 is inserted in the inlay cavity 17 of the slide body 10 and further inserted in the locating opening 22 of the slide insert 20. Then although the slide insert 20 is small to accord with the small plastic product, it is fixed in the slide body 10 very steadily.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A slide having a fixing mechanism of a slide insert, comprising:
a slide body, having a front wall, a top wall and two sidewalls, the front wall defining a receiving hole, the sidewall defining an inlay cavity which passes through the receiving hole;
a slide insert, held in the receiving hole, having a moldboard on one end, and the moldboard stretching out of the front wall of the slide body, the slide insert defining a locating opening on one side thereof; and
a slide core, inserted in the inlay cavity of the slide body and further inserted in the locating opening of the slide insert.

2. The slide having the fixing mechanism of the slide insert as claimed in claim 1, wherein the slide core is a rectangular batten, correspondingly, the locating opening of the slide insert is rectangular.

3. The slide having the fixing mechanism of the slide insert as claimed in claim 1, wherein the top wall of the slide body defines an inserting cavity which stretches from the top wall to the bottom, and the inserting cavity inclines backwards.
